(19) United States
(12) Patent Application Publication
(10) Pub. No.: US 2005/0195368 A1
(43) Pub. Date: Sep. 8, 2005

(54) Three dimensional shadow projection system and method for home use

(76) Inventor: Stanley T. Bissinger, Minneapolis, MN (US)

Correspondence Address: MAEYAERT & MAEYAERT, 2091 COUNTY ROAD D EAST, SUITE C-100, MAPLEWOOD, MN, 55109, US

(21) Appl. No.: 11/069,644

(22) Filed: Mar. 1, 2005

Related U.S. Application Data
(60) Provisional application No. 60/549,061, filed on Mar. 2, 2004.

(51) Int. Cl. G03B 21/14

(52) U.S. Cl. 353/10

(57) ABSTRACT

A shadow projection system for creating three dimensional shadowing effects in a home environment having a projector with an enclosure for damping reflected light, the projector including a two point pinpoint light source that are less than 0.5 inches in height and less than 0.25 inches in width and have bulbs and non-reflective components so that the light source provides a uniform light projection without perceivable distortions and projects light in a generally single, parallel direction with minimal amounts of reflected light with each light source having corresponding light filters, a translucent screen, a pair of filtered viewing lenses corresponding to the corresponding light filters of the two point light source, such that a viewer looking through the pair of filtered viewing lenses perceives a three dimensional perception shadow caused by two shadows created on the translucent screen of an object placed between the two point light source and the translucent screen. A method of creating a three dimensional shadow in a home environment including: Providing a shadow projection system; placing and moving an object between the translucent screen and the projector; projecting a pair of shadows of the object with the projector on the projection side of the translucent screen; creating a pair of shadows of the object on the viewing side of the screen; and causing a viewer looking through the pair of filtered viewing lenses to perceive a moving three dimensional perception shadow caused by two shadows created on the viewing side of the translucent screen of an object placed between the two point light source and the translucent screen.

### RELATED APPLICATION

This application claims the benefit of U.S. Provisional Application Ser. No. 60/549,061, filed Mar. 2, 2004 under 35 USC 119(e).

### FIELD OF INVENTION

The present invention relates to the field of classic Silhouette Theater wherein actors act out a performance between a light source and a rear projection surface, and the audience watches the performance from the opposite side of the screen in the form of a moving shadow. More particularly, this invention relates to creating three dimensional shadows using anaglyph technology. The present invention provides a three dimensional system that can be used in the home.

### BACKGROUND OF INVENTION

Ever since the invention of light, people have enjoyed creating shadows on the wall. Closely on the heels of this came the use of rear screen projection, which puts the audience of the shadow theater on the opposite side of a translucent screen. Now the actor is free to execute his or her craft or artistry on the side of the light projector and move about in such a way as to create shadowy form and movement that will be appreciated by the audience on the opposite side of the screen.

The use of anaglyph technology to provide a three dimensional shadow effects is typically only utilized in perfectly dark and non-reflective areas or requires high electrical power consumption not conducive to ease of use in a home environment. If the projection and viewing area are not perfectly dark or the surrounding walls or ceilings are reflective, the ability to perceive the three dimensional effect is diminished. The ability to provide a child-safe system also limits the use of high powered electrical equipment. Current systems fail to provide highly defined shadows in combination with a device that is safe for children's use that can be used in a bedroom, playroom, living room, or similar home environments.

### SUMMARY OF INVENTION

The invention exploits the binocular nature of human sight, by using two light sources mounted horizontally approximately three inches apart as the light source. In addition, the lights are color-filtered red on the left and blue on the right. When an actor performs in the space between the light and the screen, the dual light source produces a shadow with a ridge of red on the left and a ridge of blue on the right side of the shadow. The effect of a 3D shadow is achieved when the audience views this shadow on the opposite side of the screen wearing anaglyph red and blue 3D glasses.

One aspect of the invention includes a shadow projection system having a projector including a two point light source with each light source having corresponding light filters, a translucent screen, a pair of filtered viewing lenses corresponding to the corresponding light filters of the two point light source, such that a viewer looking through the pair of filtered viewing lenses perceives a three dimensional perception shadow caused by two shadows cast on the translucent screen of an object placed between the two point light source and the translucent screen. The light sources may be pinpoint light sources such as LEDs, halogen bulbs or small incandescent bulbs. The light sources may be pinpoint light sources with non-reflective components so that the light source projects light in a generally single, parallel direction with minimal amounts of reflected light. The light sources may be light bulb or lamp elements that are less than 0.5 inches in height and less than 0.25 inches in width and have uniform projection of light with non-perceptible shadows or distortions. The light sources may create three dimensional shadowing effects in conditions in a home environment. The projector may include an enclosure for damping reflected light and include a non-light emitting heat vent. The translucent screen may obscure the projector and the object from the viewer and provide balance in the overall projected light. The translucent screen may be comprised of polyethylene.

Another aspect of the invention includes a projector for a shadow projection system having a two point pinpoint light source with each light source having corresponding light filters such that a viewer looking through a pair of corresponding filtered viewing lenses perceives a three dimensional perception shadow caused by two shadows cast on a translucent screen of an object placed between the two point light source and the translucent screen, wherein the projector includes an enclosure for damping reflected light, and wherein the light sources create three dimensional shadowing effects in a home environment.

Another aspect of the invention includes a method of creating a three dimensional shadow including: Providing a projector having a two point light source, each light source having corresponding light filters, a translucent screen having as projection side and a viewing side, a pair of filtered viewing lenses corresponding to the corresponding light filters of the two point light source; placing and moving an object between the translucent screen and the projector; projecting a pair of shadows of the object with the projector on the projection side of the translucent screen; creating a pair of shadows of the object on the viewing side of the screen; and causing a viewer looking through the pair of filtered viewing lenses to perceive a moving three dimensional perception shadow caused by two shadows created on the viewing side of the translucent screen of an object placed between the two point light source and the translucent screen. The method may include three dimensional shadowing effects created in a home environment. The method may further include obscuring the projector and the object from the viewer with the translucent screen and balancing the overall projected light with the translucent screen.

Another aspect of the invention includes a shadow projection system including a projection means for providing a two point filtered light source, screen means for providing a viewing medium for a viewing shadow, viewing means for filtering a portion of a viewing shadow, wherein a viewer looking through the viewing means perceives a three dimensional perception of an object placed between the projection means and the screen means by viewing shadows cast on the screen means in conditions with partial light. The shadow projection system may include a projection means having an enclosure for damping reflected light and a two point pinpoint light source, each light source having corresponding light filters, and wherein the light sources create three dimensional shadowing effects in a home environment.

### BRIEF DESCRIPTION OF THE DRAWINGS

FIG. 1 is a three dimensional drawing of a three dimensional shadow system from the projection side of the screen.

FIG. 2 is a three dimensional drawing of a three dimensional shadow system from the viewing side of the screen.

FIG. 3 is a three dimensional drawing of a three dimensional shadow system from the projection side and above the screen.

FIG. 4 is a three dimensional drawing of a three dimensional shadow system from above the screen.

FIG. 5 is three dimensional drawing of the alternate projector of a three dimensional shadow system.

FIG. 6 is three dimensional drawing of the alternate projector of a three dimensional shadow system with the front panel and lamps removed.

### DESCRIPTION OF THE PREFERRED EMBODIMENT

Generally, one embodiment of the three dimensional shadow projection system consists of a two point source of lamps positioned horizontally approximately three inches apart, and four feet off the floor. The left lamp has a red gelatin filter and the right lamp has a blue gelatin filter. Both lamps project approximately six to ten feet in a single direction, in parallel towards a white rear translucent surface. Actors with props performing directly in the path of the dual lamps' projection on the screen cast shadows on the rear side of the projection screen.

The three inch displacement of the lamps produces a shadow cast by the actors and their props on the screen that has a ridge of red on the left edge and a ridge of blue on the right edge.

The audience members stand on the opposite side of the rear screen projection surface approximately six to ten feet away from the screen looking towards the screen wearing red and blue anaglyph three dimensional glasses. The left eye of the viewer looks at the shadow through a red filter and only sees the blue shadow. The right eye looks through the blue lens and only sees the red shadow. The viewer sees a single shadow. Due to the blocking effect of the red filter, the left eye is actually seeing a slightly different reveal of the actor's shadow than the right eye sees. These two slightly different reveals of the actors shadow are fused together in the viewers mind much the same way that actual three dimensional objects are fused by anyone with normal binocular vision. What makes the effect so exceptional is that the shadow appears to be an integrated translucent gray volume that mimics the form of the actor on the opposite side of the screen. The second feature of this effect is that the orientation of the 3D shadow on the viewer side of the screen is the reverse of the actor on the projector side of the screen. So when the actor has his or her back to the audience and faces the projection lamps, the appearance of the shadow on the viewer side is facing the audience.

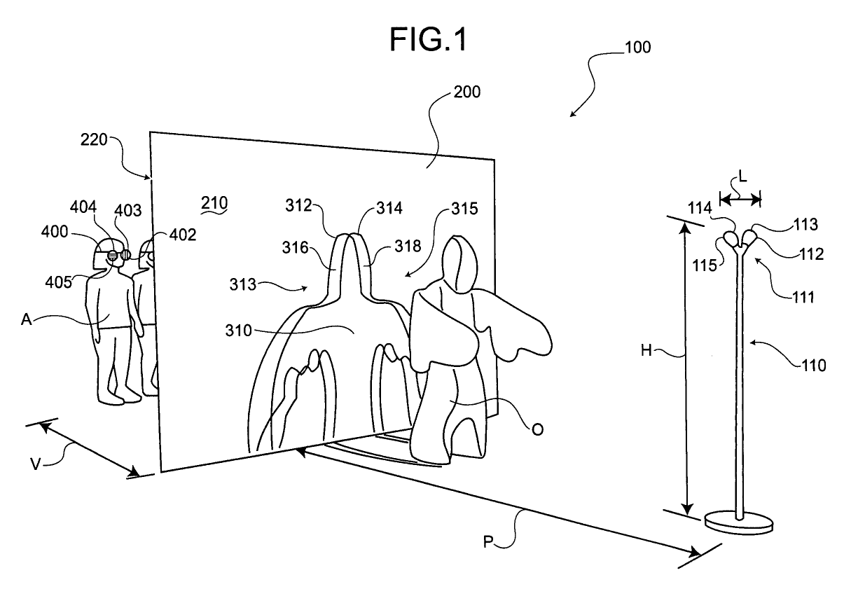

Referring now to FIG. 1, one embodiment of the three dimensional shadow projection system 100 includes a projector 110. Projector 110 comprises a two point light source 111 of a left lamp 112 and a right lamp 114 spaced and positioned horizontally to each other a lamp spacing L of approximately three inches apart, and an elevation distance E of approximately four feet off the floor. Projector 110 is located a projection distance P from the screen 200. Lamp spacing L may be variable from approximately one inch to approximately 4 inches depending on the projection distance P and the overall shadow effect desired. Projection distance P is approximately six to ten feet. Left lamp 112 has a red gelatin light filter 113 and right lamp 114 has a blue gelatin light filter 115. Both lamps 112 and 114 project in a generally single, parallel direction towards screen 200. Screen 200 is comprised of a white translucent surface that has a projection surface 210 facing the projector 110 and a viewing surface 220 facing the audience A. Object 0, such as actors with props, located between the projector 110 and the screen 200 cast shadows on projection surface 210.

The lamp spacing L of the two point light source 111 of projector 110 causes a projection shadow 310 cast by object O on the projection surface 210. Projection shadow 310 comprises two parts, a red projection shadow 312 and a blue projection shadow 314. Red projection shadow 312 and blue projection shadow 314 overlap so that projection shadow 310 has a ridge of red or exposed red shadow component 316 on the left edge 313 of projection shadow 310 and a ridge of blue or exposed blue shadow component 318 on the right edge 315 of projection shadow 310. Note that the red projection shadow 312 and the blue projection shadow 514 are not symmetrical due to the lamp spacing L of the two point light source.

The audience A stands on the opposite side of the screen 200 as the projector 110 and the object O. Audience A faces viewing surface 220 of screen 200 and is positioned a viewing distance V from screen 200. Viewing distance V is approximately six to ten feet. Audience A views the viewing surface 220 through glasses 400 towards screen 200. Glasses 400 comprise anaglyph three dimensional lenses comprising a left lens 402 having a red filter 403 and right lens 404 having a blue filter 405.

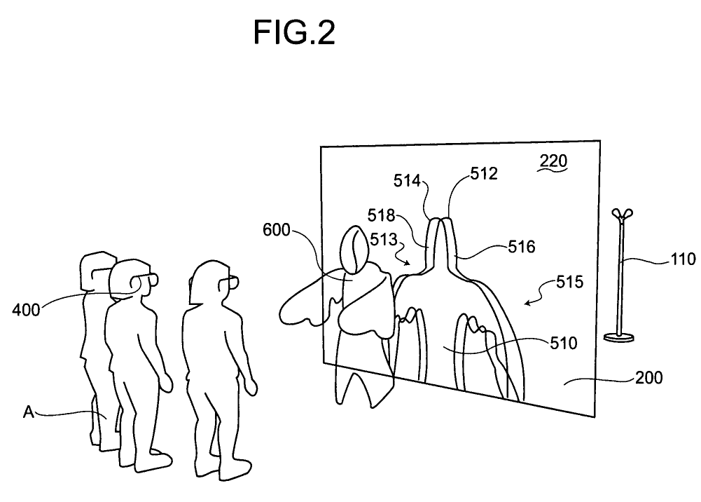

Now referring to FIG. 2, Screen 200 is comprised of a white translucent material so that projection shadow 310 passes through screen 200 to viewing surface 220 facing the audience A creating viewing shadow 510 on viewing surface 220. Screen 200 may be comprised of different types of materials such as 4 mil polyethylene or typical rear monochrome projection screen material varying from white to gray to black so long as a shadow is projected through the screen. In most applications, some opacity of screen 200 is desired to obscure the actor or object O from the audience A as well as obscuring the light projector 110. The screen 200 also preferably provides enough diffusion of the two point light source 111 to reduce hot spots in the lighting and provide balance in the overall projected light.

The viewing shadow 510 comprises two parts, a red viewing shadow 512 and a blue viewing shadow 514. Red viewing shadow 512 and blue viewing shadow 514 overlap so that viewing shadow 510 has a ridge of red or exposed red shadow component 516 on the right edge 515 of viewing shadow 510 and a ridge of blue or exposed blue shadow component 518 on the left edge 513 of viewing shadow 510. Note that red projection shadow 312 is on the left side of projection surface 210, but red viewing shadow 512 is on the right side of viewing surface 220.

Referring again to glasses 400 with a left lens 402 having a red filter 403 and right lens 404 having a blue filter 405, the left eye of the audience A looks at viewing shadow 510 through red filter 403 and only sees the blue viewing shadow 514. The right eye of Audience A looks through the blue filter 405 and only sees the red viewing shadow 512. This results in the audience perceiving a single perception shadow 600. Note that the red viewing shadow 512 and the blue viewing shadow 514 are not symmetrical so that the perception shadow 600 appears as a three-dimensional image to the audience A when viewed through glasses 400.

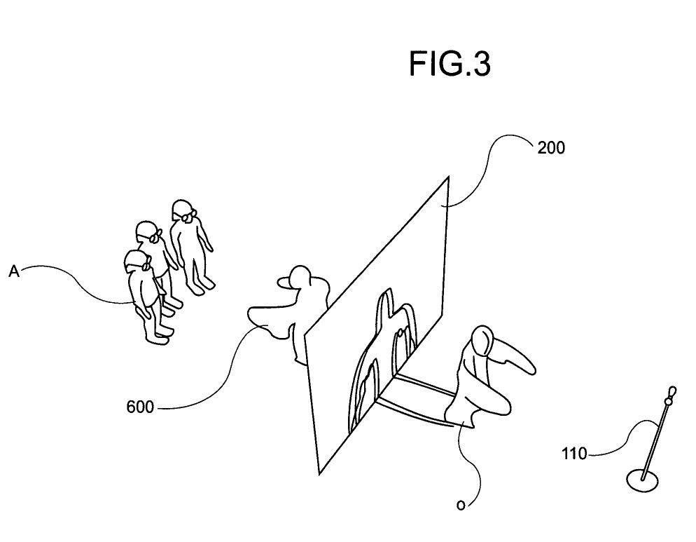

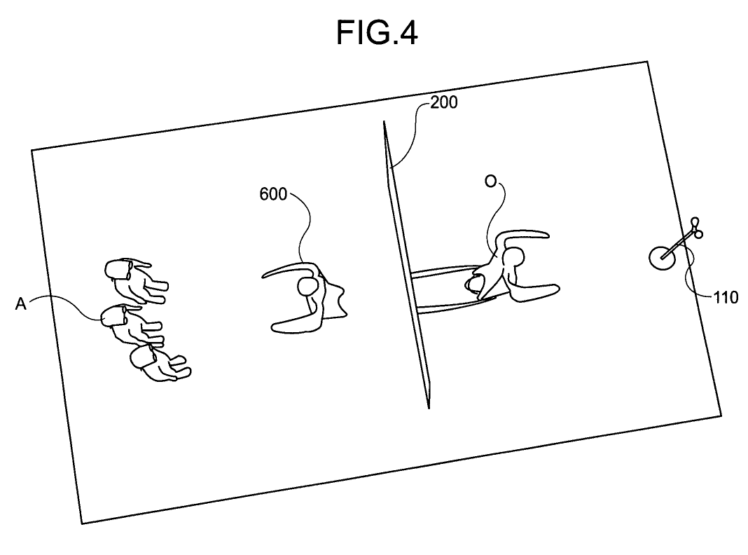

Referring now to FIG. 3 and FIG. 4, note that as object O is moved about the area between projector 110 and screen 200, perception shadow 600 moves about the area between screen 200 and audience A at the same time in real time. Perception shadow 600 appears as a three-dimensional image due to the left eye actually seeing a slightly different reveal of the viewing shadow 510 than the right eye sees. These two slightly different reveals of the perception shadow 600 are caused by the non-symmetrical nature of the two different colored shadows 512, 514 of viewing shadow 510 as they are fused together in the viewers mind much the same way that actual three dimensional objects are fused by anyone with normal binocular vision. What makes the effect so exceptional is that the perception shadow 600 appears as a total integrated translucent gray volume that mimics the form of the object O on the opposite side of screen 200. The second feature of this effect is that the orientation of the perception shadow 600 on the viewer or audience side of screen 200 is the reverse of the object O on the projector side of screen 200. So when the actor or object O has his or her back to the audience and faces the projector 110, the appearance of the perception shadow 600 on the viewer side is facing audience A.

The three-dimensional shadow effect can also be created by reversing the red and blue colors or by using different color combinations instead of red and blue such as red and cyan, red and green, or by using opposed Polaroid filters such as vertical and horizontal.

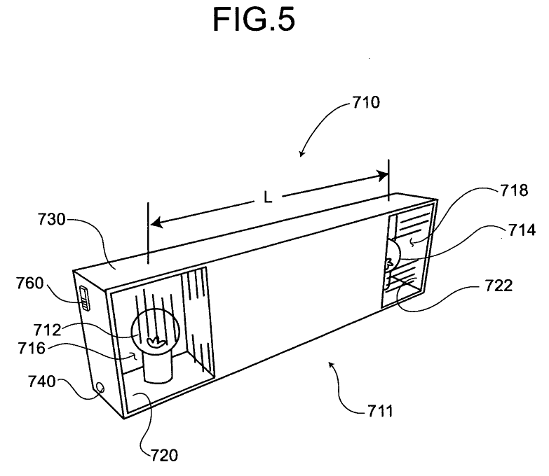

Referring now to FIG. 5, an alternative embodiment projector 710 of the three dimensional shadow projection system 100 is shown. Projector 710 comprises an enclosure 730, a two point light source 711, and filters 716, 718. The two point light source 711 comprises a left lamp 712 and a right lamp 714 spaced and positioned horizontally to each other a lamp spacing L of approximately three inches apart. Projector 710, similar to projector 110, is located a projection distance P from the screen 200 as previously indicated in FIG. 1. Lamp spacing L may be permanently or temporarily variable from approximately one inch to approximately 4 inches depending on the projection distance P and the overall shadow effect desired. In some cases more exaggeration, hyper realization, under realization, or ghosting effect is desired and can be accomplished by adjusting the lamp spacing L. Projection distance P is approximately six to ten feet. Left lamp 712 has a red filter 716 and right lamp 714 has a blue filter 718. Lamps 712 and 714 project light in a generally single, parallel direction towards screen 200. Lamps 712, 714 are low wattage bulbs, such as halogen, small incandescent or LED bulbs, LED bulbs are preferred. A pinpoint light source with a uniform projection is desired without caustic light shadows created by some LED bulbs. A light source that does not introduce shadows or hot spots that are perceptible by the viewer is desired. The bulb element or filament 720 may be up to about 0.25 inch in width and 0.5 inch in width so as to provide a minimal amount of distortion and blurring of the three-dimensional perceived image 600. A tall or long filament reduces top to bottom clarity, a wide filament reduces side to side clarity. Some light bulbs, such as those typically used in the home, have elements that are too large or have frosted glass that creates a diffuse light source that is not a pinpoint light source.

Filters 716, 718 may be a gelatin type filter material or other type of colored medium that corresponds to filters 403, 405 in lenses 402, 404 as previously described in FIG. 1. Note that the color for right lamp 714 matches the color for the left filter 403 and lens 402 of glasses 400.

Lamps 712, 714 are partially surrounded by non-reflective components 720 and 722 that reduce the amount of reflected light. Non-reflective components may be simply a high temperature non-reflective coating or may be an inserted component that is positioned between the bulb and the remainder of the projector 710 so that the light source projects light in a generally single, parallel direction with minimal amounts of reflected light. Projector may be either battery powered or AC powered and supplied via power connector 740. Power connector 740 may be either an AC cord plug or a DC adapter. Power to the projector can be turned on by switch 750.

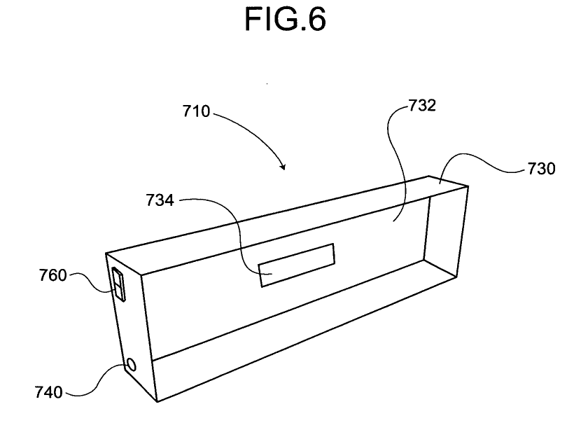

Referring now to FIG. 6, Projector 710 is shown with the filters 716, 718 and the front panel of enclosure 730, and lamps 712, 714 removed. Projector 710 includes an enclosure 730 that surrounds lamps 712, 714 except for the portion in front of lamps 712, 714 so that lamps 712 and 714 can project light in a generally single, parallel direction towards screen 200. Enclosure 730 captures light that is not directed toward the screen. The enclosure 730 is light tight to diminish reflected light. The enclosure may be comprised of plastic material. The shape of the enclosure may also be designed to capture and minimize reflected light and allow heat from the bulbs to safely escape. A back panel 732 may have a vent opening, for example, to be used to relieve the buildup of heat without letting light escape.

It is to be understood that the above description is intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled.

1. A shadow projection system comprising:
a projector comprising a two point light source, each light source having corresponding light filters,
a translucent screen,
a pair of filtered viewing lenses corresponding to the corresponding light filters of the two point light source, and
wherein a viewer looking through the pair of filtered viewing lenses perceives a three dimensional perception shadow caused by two shadows cast on the translucent screen of an object placed between the two point light source and the translucent screen.

2. The shadow projection system of claim 1 wherein the light sources are pinpoint light sources with non-reflective components so that the light source projects light in a generally single, parallel direction with minimal amounts of reflected light.

3. The shadow projection system of claim 1 wherein the light sources are less than 0.5 inches in height and less than 0.25 inches in width and have a uniform light projection without perceivable distortions.

4. The shadow projection system of claim 1 wherein the light sources create three dimensional shadowing effects in conditions with partial light in a home environment.

5. The shadow projection system of claim 1 wherein the projector comprises an enclosure for damping reflected light.

6. The shadow projection system of claim 5 wherein the inside of the enclosure has a non-light emitting vent for relieving heat.

7. The shadow projection system of claim 1 wherein the translucent screen obscures the projector and the object from the viewer and provides balance in the overall projected light.

8. The shadow projection system of claim 1 wherein the translucent screen is comprised of polyethylene.

9. A projector for a shadow projection system comprising:
a two point pinpoint light source, each light source having corresponding light filters and non-reflective components so that the light source projects light in a generally single, parallel direction with minimal amounts of reflected light,
wherein a viewer looking through a pair of corresponding filtered viewing lenses perceives a three dimensional perception shadow caused by two shadows cast on a translucent screen of an object placed between the two point light source and the translucent screen,
wherein the projector comprises an enclosure for damping reflected light, and
wherein the light sources create three dimensional shadowing effects.

10. The projector of claim 9 wherein the inside of the enclosure has a non-light emitting vent for relieving heat.

11. The projector of claim 9 wherein the light sources are bulbs with uniform light projection without perceivable distortions.

12. A method of creating a three dimensional shadow comprising:
providing a projector comprising a two point light source, each light source having corresponding light filters, a translucent screen having as projection side and a viewing side, a pair of filtered viewing lenses corresponding to the corresponding light filters of the two point light source,
placing and moving an object between the translucent screen and the projector,
projecting a pair of shadows of the object with the projector on the projection side of the translucent screen,
creating a pair of shadows of the object on the viewing side of the screen, and
causing a viewer looking through the pair of filtered viewing lenses to perceive a moving three dimensional perception shadow caused by two shadows created on the viewing side of the translucent screen of an object placed between the two point light source and the translucent screen.

13. The method of claim 12 wherein the three dimensional shadowing effects are created in a home environment.

14. The method of claim 12 wherein the light sources are bulbs and non-reflective components so that the light source provides a uniform light projection without perceivable distortions and projects light in a generally single, parallel direction with minimal amounts of reflected light.

15. The method of claim 12 wherein the projector comprises an enclosure for damping reflected light.

16. The method of claim 12 wherein the inside of the enclosure has a non-light emitting vent for relieving heat.

17. The method of claim 12 further comprising obscuring the projector and the object from the viewer with the translucent screen and balancing the overall projected light with the translucent screen.

18. A shadow projection system comprising
projection means for providing a two point filtered light source,
screen means for providing a viewing medium for a viewing shadow,
viewing means for filtering a portion of the viewing shadow,
wherein a viewer looking through the viewing means perceives a three dimensional perception of an object placed between the projection means and the screen means by viewing shadows cast on the screen means in a home environment.

19. The shadow projection system of claim 18 wherein the projection means comprises an enclosure for damping reflected light and a two point pinpoint light source, each light source having corresponding light filters, and wherein the light sources create three dimensional shadowing effects.

20. The shadow projection system of claim 19 wherein the inside of the enclosure has a non-light emitting vent for relieving heat.

21. The shadow projection system of claim 19 wherein the light sources are less than 0.5 inches in height and less than 0.25 inches in width and have minimal caustics.

22. The shadow projection system of claim 19 wherein the light sources are bulbs and non-reflective components so that the light source provides a uniform light projection without perceivable distortions and projects light in a generally single, parallel direction with minimal amounts of reflected light.
